(19) United States
(12) Patent Application Publication
(10) Pub. No.: US 2022/0357162 A1
(43) Pub. Date: Nov. 10, 2022

(54) BATTERY MANAGEMENT DEVICE, LEARNING MODEL, COMPUTER PROGRAM, BATTERY MANAGEMENT METHOD, AND INFORMATION PROVIDING DEVICE

(71) Applicant: GS Yuasa International Ltd., Kyoto (JP)

(72) Inventor: Satoshi OKUDA, Kyoto (JP)

(21) Appl. No.: 17/638,466

(22) PCT Filed: Mar. 23, 2020
(86) PCT No.: PCT/JP2020/012779

§ 371 Date: Feb. 25, 2022

(30) Foreign Application Priority Data
Aug. 28, 2019 (JP) 2019-156000

(51) Int. Cl. G01C 21/32; G01C 21/34; G01C 21/36

(52) U.S. Cl. CPC G01C 21/32; G01C 21/3469; G01C 21/367

(57) ABSTRACT

A battery management device includes a calculating unit that calculates a movable distance based on a state of charge of an energy storage device serving as a power source of the electric moving body. The calculation unit of the battery management device is configured to: acquire a state of charge of the energy storage device; acquire environmental information in a planned route of the electric moving body; calculate, from the acquired state of charge and environmental information, a power consumption amount predicted based on a watt-hour necessary for the electric moving body to move along the planned route and a prediction of a power consumption amount in an installation mounted on the electric moving body; and calculate a movable distance achieved by remaining power of the energy storage device based on the calculated predicted power consumption amount and the state of charge.

### CROSS REFERENCE TO RELATED APPLICATIONS

This application is a national stage application, filed under 35 U. S.C. § 371, of International Application No. PCT/JP2020/012779, filed Mar. 23, 2020, which international application claims priority to and the benefit of Japanese Application No. 2019-156000, filed Aug. 28, 2019; the contents of both of which as are hereby incorporated by reference in their entireties.

### BACKGROUND

### Technical Field

The present invention relates to a battery management device, a learning model, a computer program, a battery management method, and an information providing device capable of presenting a movable distance with high accuracy.

### Description of Related Art

With the spread of electric automobiles, unmanned aerial vehicles so-called drones, and the increase of electric moving bodies such as the practical application of electric manned aerial vehicles and electric ships, the demand for charging stands is also increasing. Although it can be said that the number of charging stands is sufficient in urban areas, it cannot be said that the installation density of charging stands in areas other than urban areas is sufficient, and a user of the electric moving body needs to drive while grasping the position of the charging stand.

Patent Document JP-A-2012-160022 discloses a charging stand management system that calculates a travelable distance based on a storage amount of a storage battery mounted on an electric automobile and road traffic information, determines whether or not a set final destination can be reached, and searches for and presents a charging stand where charging is possible when the final destination cannot be reached.

### BRIEF SUMMARY

Although the installation density of the charging stand is sufficient in urban areas, there may be a case where unexpected power consumption is required, such as traffic congestion in the case of an automobile, and arrival/departure standby or bad weather in the case of an airplane. In an electric automobile that does not include an engine, when an unexpected event such as traffic congestion occurs particularly in a period of using heating or in a route to a charging station in areas other than urban areas, there is a possibility that the user feels uneasy about whether or not traveling is possible to the proposed charging station. Also in the case of an electric airplane, in a case where the waiting time at the time of getting in and out of a passenger is long or the wind speed is unexpected, there is a possibility that the passenger feels uneasy about whether or not movement on the planned route is possible.

An object of the present invention is to provide a battery management device, a learning model, a computer program, a battery management method, and an information providing device that accurately present a movable distance according to a situation of a planned moving route of an electric moving body.

A battery management device according to one aspect of the present invention includes a calculating unit that calculates a movable distance based on a state of charge of an energy storage device serving as a power source of the electric moving body. The calculation unit is configured to: acquire a state of charge of the energy storage device; acquire environmental information in a planned route of the electric moving body; calculate, from the acquired state of charge and environmental information, a power consumption amount predicted based on a watt-hour necessary for the electric moving body to move along the planned route and a prediction of a power consumption amount in an installation mounted on the electric moving body; and calculate a movable distance achieved by remaining power of the energy storage device based on the calculated predicted power consumption amount and the state of charge.

According to the present disclosure, it is possible to accurately calculate a state of charge (SOC) of an energy storage device serving as a power source of an electric moving body, and to accurately present a movable distance according to traffic congestion or an accident, an influence of weather, and a power consumption situation of an installation provided in a moving body.

### BRIEF DESCRIPTION OF THE FIGURES

FIG. 1 is a block diagram of an information providing system including a battery management device.

FIG. 2 is a flowchart illustrating an example of a processing procedure executed by the battery management device.

FIG. 3 is a flowchart illustrating another example of a processing procedure executed by the battery management device.

FIG. 4 is a block diagram illustrating a configuration of the battery management device in the second embodiment.

FIG. 5 is a schematic diagram of a learning model in the battery management device.

FIG. 6 is a flowchart illustrating an example of a calculation procedure of a travelable distance based on the learning model.

FIG. 7 is a schematic diagram of another example of the learning model.

FIG. 8 is a flowchart illustrating another example of the calculation procedure of the travelable distance using the learning model.

FIG. 9 is a flowchart illustrating an example of a calculation procedure of a travelable distance in the third embodiment.

FIG. 10 is a flowchart illustrating an example of a calculation procedure of a travelable distance in the fourth embodiment.

FIG. 11 is a diagram illustrating an example of a charging message to be output.

FIG. 12 is a schematic diagram of the information providing system in the fifth embodiment.

FIG. 13 is a flowchart illustrating an example of a processing procedure executed by the battery management device according to the fifth embodiment.

### DETAILED DESCRIPTION OF VARIOUS EMBODIMENTS

A battery management device includes a calculating unit that calculates a movable distance based on a state of charge of an energy storage device serving as a power source of the electric moving body. The calculation unit is configured to: acquire a state of charge of the energy storage device; and acquire environmental information in a planned route of the electric moving body. The calculation unit is configured to calculate, from the acquired state of charge and environmental information, a power consumption amount predicted based on a necessary watt-hour necessary for the electric moving body to move along the planned route and a prediction of a power consumption amount in an installation mounted on the electric moving body. The calculation unit is configured to calculate a movable distance achieved by remaining power of the energy storage device based on the calculated predicted power consumption amount and the state of charge.

With the above configuration, the power consumption amount in the planned route is calculated based on the prediction of the usage status of the installation according to the status of the planned route of movement and the environmental status. In the planned route, there is a possibility that a situation different from the state at the place where the moving body is moving at that time occurs. The prediction of the power consumption amount in the planned route takes into consideration prediction of the watt-hour necessary for the movement of the electric moving body itself based on an average travel time using congestion information and environmental information such as an outside temperature, a wind speed, and a wave height affecting movement and an average speed, and prediction of the power consumption amount of the installation obtained according to the environmental information.

The “electric moving body” is a vehicle such as an electric automobile, an airplane, or a ship on which an energy storage device is mounted. The electric moving body may be manned or unmanned. In the “electric moving body”, at least a part of a driving power source may be the energy storage device, and the power source may partially include other power such as an engine.

In a case where the electric moving body is an electric airplane, a sound generated from a motor, a propeller, or the like is large. When the outside air is introduced for temperature adjustment, the noise enters. Therefore, in the case of a manned vehicle, an air conditioning installation may be used. In the case of flying at a high altitude, the outside temperature is low, so that air conditioning is required to prevent a decrease in temperature of a cabin and the energy storage device. When a window is fogged due to humidity or temperature, it is necessary to prevent fogging by air conditioning or heating wires. As described above, in the electric moving body, the power consumption amount in the installation changes under the influence of the location of the moving route or time. Therefore, not only the watt-hour necessary for the movement of the electric moving body itself but also the power consumption amount in the installation are taken into consideration.

The power consumption amount of the energy storage device is calculated not only in the transition of the power consumption amount up to the calculation time point but also in the planned route after the calculation time point, and the movable distance is calculated from the calculated predicted power consumption amount. Since the battery management device connected to the energy storage device can accurately predict the power consumption amount based on the characteristics of the energy storage device, the movable distance is calculated.

The calculation unit may be configured to: divide the planned route of the electric moving body; predict the necessary watt-hour and the power consumption amount in the installation based on the environmental information for each divided section; determine, for each section, whether or not the electric moving body is movable in the section based on the state of charge; and calculate a distance to a section determined not to be movable as a movable distance.

The environmental information may include traffic congestion information. The traffic congestion information may be provided by information such as a traffic congestion length for each section of the route, an average travel time for each time in the section, and an average speed. In order to effectively use the provided information, by predicting the power consumption amount for each section in accordance with the provided information, the predicted power consumption amount in the planned travel route can be accurately calculated. By accurately calculating the predicted power consumption amount, the movable distance is accurately calculated.

The calculation unit may be configured to calculate a movable distance by using a learning model learned so as to output a movable distance using the energy storage device having the state of charge as a power source according to an input of the state of charge of the energy storage device, congestion information in the planned route, and the predicted power consumption amount calculated for the planned route.

The movable distance is affected by conditions that are difficult to calculate by determination based on comparison with each threshold, such as individual characteristics of the energy storage device, a moving speed, driving characteristics of a driver, a set temperature of an air conditioning installation, an outside temperature, humidity, a wind speed, a wave height, and characteristics of the moving body. By using a learning model based on deep learning for inputting these pieces of information, it is possible to accurately calculate the movable distance in consideration of the characteristics of the energy storage device.

The calculation unit may be configured to calculate a movable distance using a learning model learned so as to output a movable distance using the energy storage device having the state of charge as a power source or a temporal change in the state of charge after a calculation time point of the energy storage device according to an input of a temporal change in the state of charge of the energy storage device up to the calculation time point, a congestion time distribution predicted for the planned route, and an expected distribution of an outside temperature in the planned route.

The movable distance is affected by situations inside and outside the moving body such as a congestion situation of a moving route, a change in temperature, a change in humidity, and the like that change with time. It is difficult to simulate the situations inside and outside the moving body based on the situation at each time point. The data that changes temporally can be imaged and input to the learning model, and the actual movable distance or the temporal change of the state of charge can be learned so as to be output as teacher data. With the above configuration, it is possible to accurately obtain the temporal change prediction of the movable distance or the state of charge by inputting the temporal change, the temporal distribution of the congestion prediction, and the predicted distribution of the change in the outside temperature.

The learning model may input a planned route time of the planned route.

The movable distance is affected by situations inside and outside the moving body such as a congestion situation of a moving route, a change in temperature, a change in humidity, and the like that change with time. In particular, at winter nighttime, summer daytime, and high altitude, the power consumption of air conditioning is large, and when the power consumption is estimated only by the watt-hour necessary for movement, there is a possibility that the power will be insufficient during the travel. Therefore, the accurate calculation can be expected by inputting the time information of the target for calculating the movable distance.

The battery management device may be configured to determine whether or not traveling along an entire route of the planned route is possible based on the calculated movable distance. A message prompting charging of the energy storage device may be output in advance when it is determined that traveling is not possible in a part of the planned travel route.

Since the movable distance is accurately predicted, charging necessary for traveling without charging on the way can be promoted. An output unit may include a speaker and output a message by voice, or a display mounted on the electric moving body may output a message by characters or images. A user or an operator of the moving body can grasp the power necessary at least to the destination not to full charge in advance rather than after the power decreases. A user or an operator can charge necessary power by selecting any one from a charging stand group provided in each place.

The battery management device may be configured to: calculate a predicted power consumption amount in the part based on a predicted power consumption amount necessary for movement on the planned route and the state of charge; and output a message including a charging time or a charge amount of the pre-charging to charge power corresponding to the calculated predicted power consumption amount.

Information (charging time or charge amount) for charging a shortage from the current state of charge is output in order to travel on the entire route of the planned route without charging on the way. A user or an operator of the moving body can grasp at least how much charging should be performed at home or at a charging stand or the like managed by an owner of the moving body in order to move the planned route in advance, not after the power of the energy storage device of the moving body decreases.

The battery management device may be configured to: acquire the state of charge of the energy storage device at a predetermined timing while the battery management device is activated; determine whether or not the state of charge has become a predetermined value or less for each time the state of charge is acquired; and start calculation of a movable distance by the calculation unit when it is determined that the state of charge is equal to or less than the predetermined value.

The timing of the request for calculating the movable distance may be a timing at which an operation is performed by the driver or the owner of the moving body, or may be a timing at which the state of charge decreases to a predetermined value or less. When the driver or the owner does not recognize the decrease in the state of charge, it is possible to know that the movable distance is short. In the case of being connected to the navigation device, the battery management device may be requested at the timing when the destination is set by the navigation device.

The electric moving body is a manned vehicle. In particular, in the case of the manned vehicle, an air conditioning installation is required in order to adjust temperature in a cab or a cabin and to prevent fogging of a window. The influence of the power consumption amount of the installation is greater than in the case of an unmanned vehicle.

A power source of the electric moving body may not include an engine.

It is also possible to present a travelable distance to a hybrid electric vehicle including an engine by using any of the above-described battery management devices, but in the case of an electric automobile including no engine, accuracy of a power consumption prediction amount is required. In particular, in winter nighttime and summer daytime, the power consumption of the air conditioning in the vehicle is large, and in this case, in the electric automobile in which power cannot be generated by the operation of the engine, there is a higher possibility that the power becomes insufficient and the vehicle stops during the travel than in a hybrid vehicle including the engine.

The environmental information includes at least one of pieces of information regarding a traffic condition, traffic congestion, a congestion condition, a temperature, an atmospheric pressure, an altitude, humidity, a wind speed, a wave height, and a tidal current in a planned route.

The time required for movement varies depending on traffic information such as occurrence of an accident and unnavigability, and traffic congestion or a congestion situation, and thus the predicted power consumption amount can vary. Depending on the temperature or humidity, the power consumption amount of the energy storage device or the air conditioning installation in the cab or the cabin varies. The time required for the movement and the power required for the movement vary depending on the wind speed or the wave height, so that the predicted power consumption amount can be changed. The movable distance is accurately calculated using these pieces of information.

A battery management device may include a calculation unit configured to acquire environmental information in a planned route of movement of the electric moving body, and calculate, from an acquired state of charge and the acquired environmental information, a power consumption amount predicted based on a watt-hour necessary for the electric moving body to move along the planned route and a prediction of a power consumption amount in an installation mounted on the electric moving body, and the battery management device may be configured to determine a charge amount of the energy storage device based on the calculated predicted power consumption amount and the state of charge of the energy storage device, and charge the energy storage device with the determined charge amount.

The battery management device may not only calculate the movable distance, but also calculate the watt-hour necessary for moving along the planned route, and may perform charging by the necessary watt-hour at the timing of moving to a chargeable battery charger.

A learning model includes: an input layer configured to input a state of charge of an energy storage device serving as a power source of an electric moving body, environmental information in a planned route of the electric moving body, and a predicted power consumption amount in the planned route; an output layer configured to output a movable distance; and an intermediate layer learned based on teacher data including a state of charge of an energy storage device of the electric moving body, environmental information in a route where the electric moving body moves, an actual power consumption amount of the energy storage device, and a corresponding actual moving distance, and the learning model is used to calculate a movable distance of the electric moving body.

The learning model is learned based on the teacher data including the state of charge of the energy storage device of the actual electric moving body, the environmental information in the route where the electric moving body moves, the actual power consumption amount of the energy storage device, and the corresponding actual moving distance, whereby the movable distance can be accurately calculated.

The features of the learning model described above may be realized as a method for generating a learning model.

A computer program is configured to cause a computer configured to manage a state of an energy storage device serving as a power source of an electric moving body to execute processing. The computer program is configured to cause the computer to execute processing of: acquiring a state of charge of the energy storage device; acquiring environmental information in a planned route of the electric moving body; calculating, from the acquired state of charge and environmental information, a power consumption amount predicted based on a watt-hour necessary for the electric moving body to move along the planned route and a power consumption amount in an installation mounted on the electric moving body; and calculating a movable distance based on the calculated predicted power consumption amount and the state of charge.

In a battery management method, a movable distance achieved by remaining power in an energy storage device serving as a power source of an electric moving body is output based on a state of charge of the energy storage device. The battery management method includes processing of: acquiring a state of charge of the energy storage device; acquiring environmental information in a planned route of the electric moving body; calculating, from the acquired state of charge and environmental information, a power consumption amount predicted based on a watt-hour necessary for the electric moving body to move along the planned route and a prediction of a power consumption amount in an installation mounted on the electric moving body; and calculating a movable distance based on the calculated predicted power consumption amount and the state of charge.

An information providing device is capable of transmitting and receiving information to and from an electric moving body by communication and configured to provide information for calculating a movable distance with remaining power of an energy storage device serving as a power source of the electric moving body. The information providing device is configured to: receive information on a state of charge of the energy storage device, a planned route, and a power consumption amount; and acquire environmental information in a planned route of the electric moving body. The information providing device is configured to calculate, from the acquired state of charge and environmental information, a power consumption amount in the planned route predicted based on a watt-hour necessary for the electric moving body to move along the planned route and a power consumption amount in an installation mounted on the electric moving body. The information providing device is configured to transmit the calculated predicted power consumption amount to the electric moving body.

With the above configuration, it is possible to realize the presentation service of the movable distance in consideration of the congestion information in the planned route obtained from a plurality of electric moving bodies, the outside temperature, the actual power consumption amount, and the like. By collecting information from the plurality of electric moving bodies, it is also possible to improve accuracy or provide the information as information for each type of moving body.

The present invention will be specifically described with reference to the drawings showing embodiments thereof In first to fourth embodiments, an electric automobile will be described as an example of an electric moving body, and in the fifth embodiment, an electric airplane and a type of an electric vertical take-off and landing (eVTOL) aircraft will be described as an example of the electric moving body.

### First Embodiment

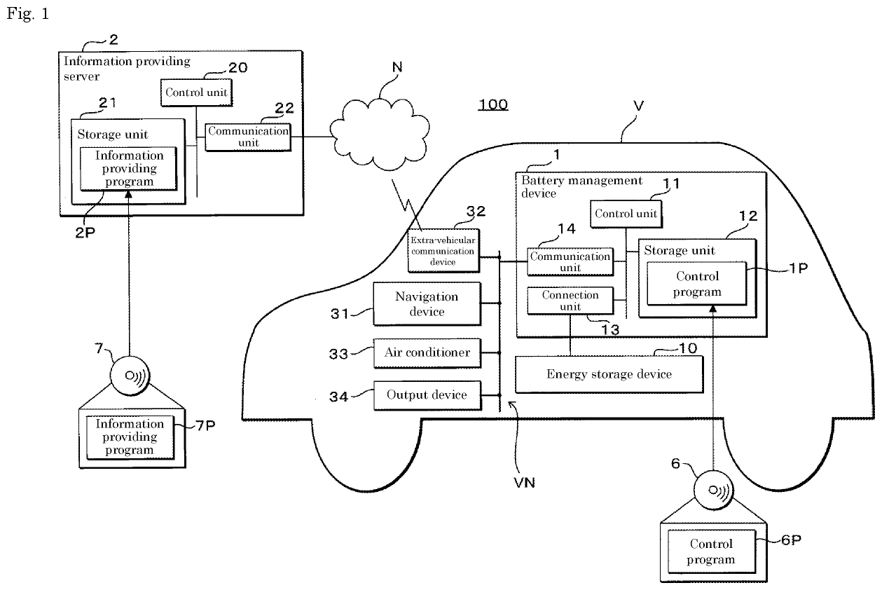

FIG. 1 is a block diagram of an information providing system 100 including a battery management device 1. The information providing system 100 includes an energy storage device 10 mounted on a vehicle V which is an electric automobile, the battery management device 1 of the energy storage device 10, and an information providing server 2.

The information providing server 2 is a server computer. The information providing server 2 is managed by a manufacturer of the energy storage device 10, and the information providing server 2 outputs information regarding a power consumption prediction amount from a departure point to a target point of a route based on map information, VICS (registered trademark), traffic information provided from each vehicle, and weather information of each point.

The battery management device 1 is connected to the energy storage device 10. The battery management device 1 may be incorporated in the energy storage device 10 which is a module including a plurality of energy storage cells.

The battery management device 1 can be communicably connected to a device capable of acquiring position information of the vehicle V and route information of a traveling plan. In the first embodiment, the battery management device 1 acquires position information of the vehicle V and route information of a traveling plan from a navigation device 31 mounted on the vehicle V, for example. In another example, the battery management device 1 may acquire position information from a global positioning system (GPS) function mounted on a communication terminal device possessed by the passenger. The battery management device 1 may acquire a planned travel route from the communication terminal device. The battery management device 1 itself may be included in the navigation device 31. The battery management device 1 may communicate with another vehicle to acquire the position information.

The battery management device 1 can be communicably connected to the information providing server 2 outside the vehicle. In the first embodiment, the battery management device 1 is communicably connected to the information providing server 2 via an extra-vehicular communication device 32 connected to an in-vehicle network VN.

The battery management device 1 can be communicably connected to an air conditioner 33 and an output device 34 via the in-vehicle network VN. The output device 34 is a device that includes a speaker and a display and can output sound or light to the passenger. The output device 34 may be integrated with the navigation device 31.

The battery management device 1 includes a control unit 11, a storage unit 12, a connection unit 13, and a communication unit 14.

The control unit 11 is a processor using a central processing unit (CPU) or a graphics processing unit (GPU). The control unit 11 may be a combination of the CPU and the GPU. The control unit 11 executes processing by controlling each component using a built-in memory such as a ROM and a RAM. The control unit 11 executes processing based on a control program 1P stored in the storage unit 12.

The storage unit 12 is, for example, a non-volatile memory such as a hard disk or a solid state drive (SSD). The storage unit 12 stores the above-described control program 1P. The control program 1P stored in the storage unit 12 may be obtained by the control unit 11 reading a control program 6P stored in a recording medium 6 and copying the control program 6P to the storage unit 12.

The storage unit 12 stores data created by the processing of the control unit 11. The storage unit 12 stores a state of charge (SOC) of the energy storage device 10. The storage unit 12 may store data regarding voltage, current, internal resistance, and temperature. The storage unit 12 stores the power consumption amount predicted by the processing of the control unit 11.

The connection unit 13 is connected to the energy storage device 10. The control unit 11 acquires measurement data including at least a voltage value among voltage, current, internal resistance, and temperature of the energy storage device 10 via the connection unit 13, and calculates an SOC. The control unit 11 may acquire an SOC calculated by an operation unit built in the energy storage device 10.

The communication unit 14 is a communication device that realizes communication connection with the information providing server 2 via the in-vehicle network VN and a network N outside the vehicle.

The information providing server 2 includes a control unit 20, a storage unit 21, and a communication unit 22.

The control unit 20 is a processor using a CPU or a GPU. The control unit 20 may be a combination of the CPU and the GPU. The control unit 20 executes processing by controlling each component using a built-in memory such as a ROM and a RAM. The control unit 20 executes processing based on an information providing program 2P stored in the storage unit 21.

The storage unit 21 is, for example, a non-volatile memory such as a hard disk or an SSD. The storage unit 21 stores the above-described information providing program 2P. The information providing program 2P stored in the storage unit 21 may be obtained by the control unit 20 reading an information providing program 7P stored in a recording medium 7 and copying the information providing program 7P to the storage unit 21.

The storage unit 21 stores data created by the processing of the control unit 20. The control unit 20 can acquire information regarding elements affecting the power consumption of the vehicle V, such as map information regarding a public communication network, VICS (registered trademark), and weather information including temperature, humidity, and the like by the communication unit 22 via the network N, and store the acquired information in the storage unit 21.

The storage unit 21 may store information regarding the power consumption prediction amount and in association with identification information for identifying at least one of the battery management device 1, the energy storage device 10, the vehicle V, and the passenger of the vehicle V.

The communication unit 22 is a communication device that realizes communication via the network N. The communication unit 22 is, for example, a network card corresponding to the network N.

The network N includes a public communication network. The information providing server 2 can acquire map information, traffic information, weather information, and position information of a charging stand from other service providers via the network N by the communication unit 22. The network N includes a carrier network and an optical beacon, and the extra-vehicular communication device 32 of the traveling vehicle V can be communicably connected to the information providing server 2.

In the information providing system 100 configured as described above, the battery management device 1 mounted on the vehicle V estimates the travelable distance in consideration of the power consumption prediction amount inside and outside the vehicle based on the position information of the vehicle V, the position information of the charging stand, the power consumption prediction amount in the travel route of the vehicle V, and the state of charge of the energy storage device 10. A part of the power consumption prediction amount is provided from the information providing server 2.

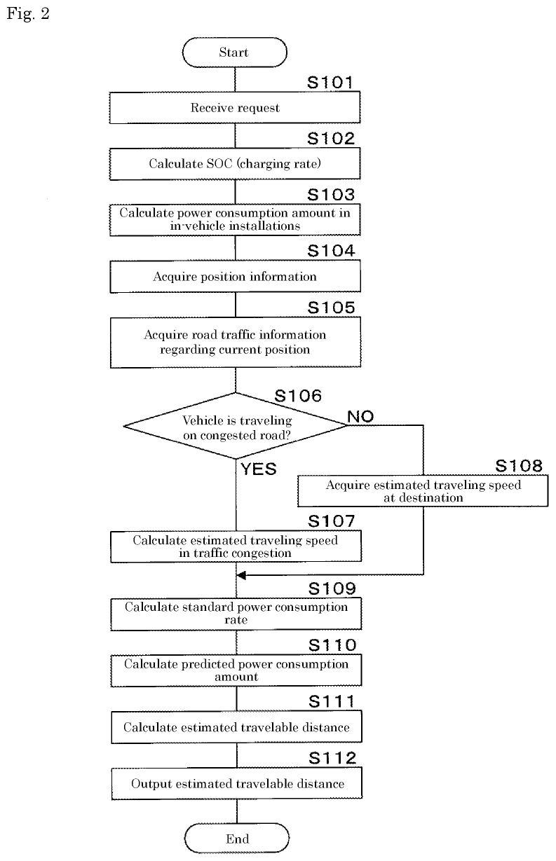

FIG. 2 is a flowchart illustrating an example of a processing procedure executed by the battery management device 1. The control unit 11 receives a request for calculating the travelable distance (step S101).

The request for calculating the travelable distance is received from a driver by a button provided in the vehicle V and operable by the driver. The request for calculating the travelable distance may be output from the navigation device 31 when a destination is set in the navigation device 31. The request for calculating the travelable distance may be output by the control unit 11 itself when the SOC becomes equal to or less than a predetermined value.

When receiving the request, the control unit 11 acquires the measurement data from the energy storage device 10 via the connection unit 13, and calculates the SOC (step S102). In step S102, the control unit 11 may acquire the calculated SOC via the connection unit 13 as described above.

The control unit 11 calculates a power consumption amount in in-vehicle installations including the air conditioner 33 (step S103). In step S103, the control unit 11 may acquire the power consumption amount periodically (for example, every 10 minutes) and calculate the power consumption amount per latest unit time (for example, 1 hour) in step S103.

In step S103, the control unit 11 may acquire an outside temperature from an in-vehicle temperature sensor, acquire an indoor temperature from the air conditioner 33, and predict the power consumption amount based on the temperature difference, or correct the power consumption amount in step S103 based on the temperature difference.

The control unit 11 acquires position information indicating the current position of the vehicle V via the communication unit 14 (step S104).

The control unit 11 acquires road traffic information regarding the current position from the information providing server 2 via the communication unit 14 (step S105). The road traffic information includes traffic congestion information of a road on which the vehicle V is traveling based on current position information of the vehicle V. The traffic congestion information of the road may be information indicating a traffic congestion point, a degree of traffic congestion, and a traffic congestion length, or may be an average estimated travel time. The road traffic information may be directly acquired not from the information providing server 2 but from VICS (registered trademark) and a traffic information center.

The control unit 11 determines whether or not the vehicle is traveling on a congested road (step S106). In step S106, the control unit 11 may make a determination based on whether or not the average speed in the past predetermined time is equal to or less than a predetermined speed (for example, 10 km/h), or may make a determination based on the information on the congested point in the traffic congestion information included in the road traffic information acquired in step S105 and the current position of the vehicle V.

When it is determined that the vehicle is traveling on a congested road (S106: YES), the control unit 11 calculates an estimated traveling speed in traffic congestion via the communication unit 14 (step S107), and advances the processing to step S109. The average per latest unit time (for example, 10 minutes) may be calculated in step S107, or the average traveling speed may be determined according to the degree of traffic congestion acquired in step S105. For example, the control unit 11 estimates the average speed according to the degree of the traffic congestion, for example, to be 10 km/h in a case where the traffic congestion is long and 20 km/h in a case where the traffic congestion is short. The control unit 11 may acquire the average traveling speed of the actual vehicle group in the congested section via the communication unit 14.

When it is determined that the vehicle is not traveling on a congested road (S106: NO), the estimated traveling speed at the destination of the traveling road is acquired (step S108), and the processing proceeds to step S109. In step S108, the control unit 11 may acquire a speed in consideration of stopping at a traffic light based on a legal speed of a road on which the vehicle V is traveling corresponding to the current position of the vehicle V.

The control unit 11 calculates a standard power consumption rate from the accumulated travel distance and power consumption amount of the vehicle V (step S109). In step S109, the control unit 11 calculates actual fuel efficiency of the energy storage device 10 of the vehicle V. In step S109, the control unit 11 may calculate the power consumption amount per unit distance from the relationship between the periodically calculated SOC and the travel distance, or may calculate the power consumption amount per unit time from the history of the periodically calculated SOC. In step S109, the control unit 11 may acquire a standard power consumption rate calculated periodically.

The control unit 11 calculates a power consumption prediction amount based on the information calculated and acquired in steps S103 to S109 (step S110). In step S110, the control unit 11 divides the current power consumption amount of the in-vehicle installation calculated in step S103 by the current speed or the estimated traveling speed to obtain the current power consumption amount (consumption rate) per distance, adds the current power consumption amount to the standard power consumption rate calculated in step S109, and calculates a power consumption prediction amount per distance. When the power consumption amount per time is calculated in step S109, it may be divided by the current speed or the estimated traveling speed.

The control unit 11 divides the total watt-hour based on the SOC acquired in step S102 by the power consumption prediction amount per distance calculated in step S110 to calculate the estimated travelable distance (step S111), outputs the estimated travelable distance to the output device 34 or the navigation device 31 (step S112), and ends the processing.

In the processing procedure illustrated in the flowchart of FIG. 2, the power consumption amount on the assumption that there is no rapid change is predicted from the current power consumption rate. In the processing procedure illustrated in the flowchart of FIG. 2, the travelable distance in a state where the destination is not set is calculated.

By presenting the travelable distance calculated in this manner, the user of the vehicle V can refer to the travelable distance based on the SOC of the in-vehicle energy storage device 10. When it can be determined that the travelable distance that can be acquired from the battery management device 1 as described above is equal to or less than the distance of the entire route with respect to the distance of the set planned route, the navigation device 31 can search for a charging stand present within the travelable distance and reset the route.

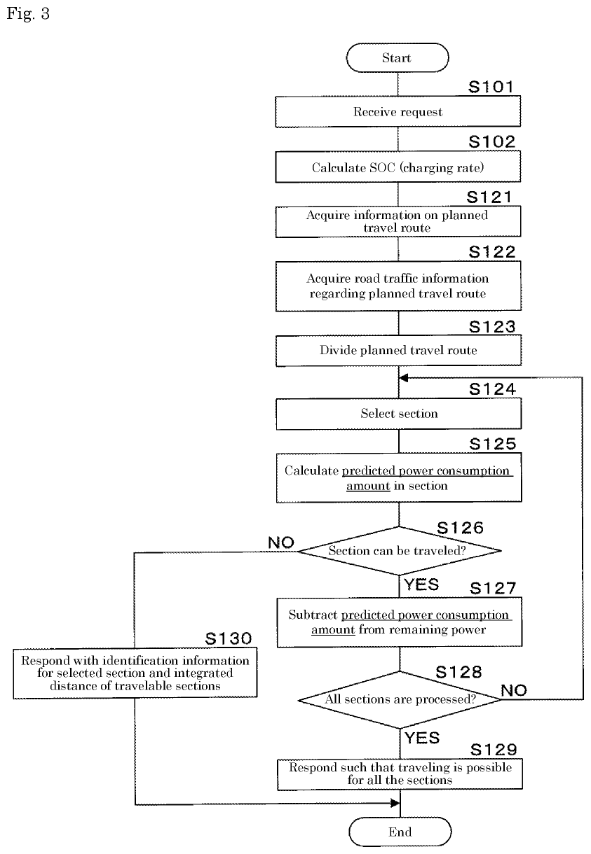

Calculation of the travelable distance regarding the set route in a case where the destination and the route are set by the navigation device 31 will be described. FIG. 3 is a flowchart illustrating another example of a processing procedure executed by the battery management device 1. Among the processing procedures illustrated in the flowchart of FIG. 3, procedures common to the procedures illustrated in the flowchart of FIG. 2 are denoted by the same step numbers, and a detailed description thereof is omitted.

The control unit 11 of the battery management device 1 receives the request for calculating the travelable distance (S101), and calculates the SOC of the energy storage device 10 (S102).

The control unit 11 acquires information on a planned travel route (step S121). The control unit 11 acquires road traffic information regarding the planned travel route via the communication unit 14 (step S122). The information on the route in step S121 is position information on the route set by the navigation device 31. The road traffic information in step S122 is traffic congestion information at the time of acquisition, and can be acquired from the information providing server 2. The traffic congestion information may be replaced with traffic congestion prediction information. The road traffic information regarding the planned travel route may be information on road undulations. The information acquired in step S122 includes information that affects power consumption, such as outside temperature.

Based on the acquired road traffic information, the control unit 11 divides the planned travel route based on the presence or absence of traffic congestion (step S123).

The control unit 11 selects the divided sections in the travel order (step S124), and calculates the power consumption prediction amount in the selected section based on traffic information (average travel time) in the section, and information such as the outside temperature in the section and the humidity in the section (step S125).

The control unit 11 determines whether or not the selected section can be traveled in the section with the remaining watt-hour of the energy storage device 10 based on the power consumption prediction amount calculated in step S125 (step S126).

When it is determined that traveling is possible (S126: YES), the control unit 11 subtracts the power consumption prediction amount from the remaining power (step S127), and determines whether or not all the sections have been processed (step S128). When it is determined that all the sections have been processed (S128: YES), the control unit 11 responds to the request with a result of determination that traveling is possible for all the sections (step S129), and ends the processing.

When it is determined in step S128 that all the sections have not been processed (S128: NO), the control unit 11 returns the processing to step S124.

When it is determined in step S126 that traveling is not possible in any section (S126: NO), the control unit 11 responds to the request with the integrated distance of the section determined to be travelable together with the information for identifying the section determined not to be travelable (step S130), and ends the processing.

In this manner, the travelable distance can be accurately obtained by accurately calculating how much power is consumed in the planned travel route by estimating from the traffic congestion information and the power consumption in the in-vehicle installation in each section instead of the average value in the entire travel.

### Second Embodiment

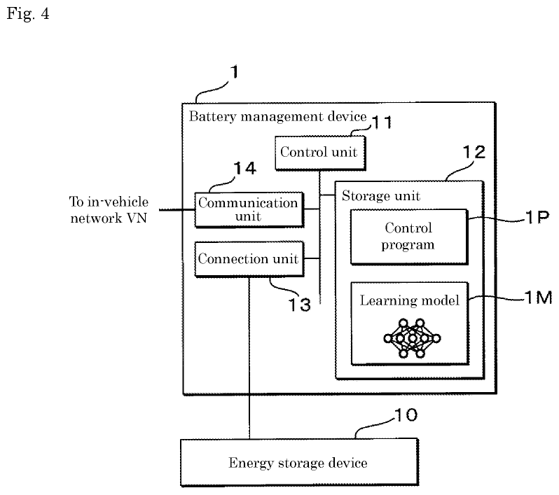

In the second embodiment, the battery management device 1 specifies the travelable distance from a learning model learned by deep learning. FIG. 4 is a block diagram illustrating a configuration of the battery management device 1 in the second embodiment. The storage unit 12 of the battery management device 1 in the second embodiment stores a learned learning model 1M in addition to the control program 1P. Configurations of the battery management device 1 and the information providing system 100 are similar to those of the first embodiment except for the processing procedure based on the learning model 1M, and thus detailed description thereof is omitted.

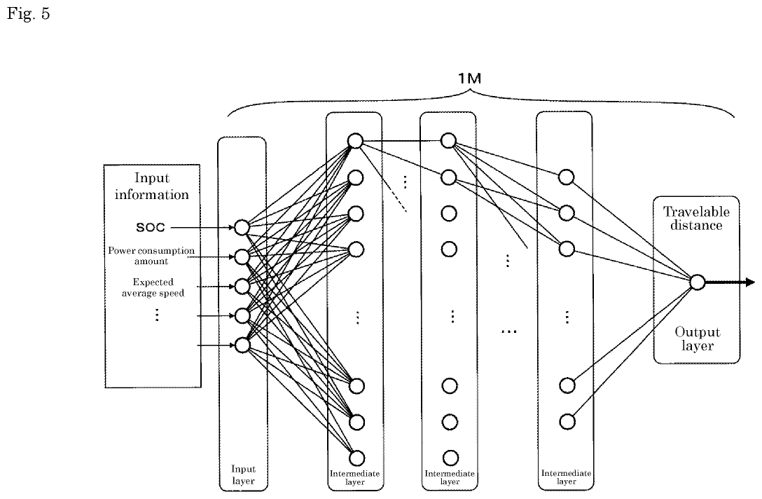

FIG. 5 is a schematic diagram of the learning model 1M in the battery management device 1. The learning model 1M is learned so as to output the travelable distance according to the input of the SOC of the energy storage device 10 at the time of input, the power consumption amount in the in-vehicle installation, and the estimated average speed in the planned travel route. In the learning model 1M, the learning model 1M outputs the travelable distance by a supervised deep learning algorithm using a neural network as illustrated in FIG. 5. The learning algorithm of the learning model 1M may be an unsupervised learning algorithm or may be a recurrent neural network.

As illustrated in FIG. 5, the neural network of the learning model 1M includes a plurality of stages of convolution layers, a pooling layer, and a fully connected layer defined by definition data, and outputs a travelable distance based on information including an input SOC.

The learning model 1M may output the estimated power consumption prediction amount per time or per distance without directly outputting the travelable distance.

The learning model 1M may be learned so as to output the travelable distance by inputting other data affecting the travelable distance of the vehicle V using the energy storage device 10 as a power source. For example, the learning model 1M may input a vehicle type. The learning model 1M may input identification information of a road on which the vehicle travels. The learning model 1M may input a traveling time.

The learning model 1M is learned by a model creating device managed by the manufacturer of the energy storage device 10 or the manufacturer of the vehicle V based on teacher data including the SOC, the power consumption amount, and the speed in the travel route of the energy storage device 10 in the actual vehicle V and the corresponding actual travel distance. Data in a large number of actually traveling vehicles V is collected and learned. For each vehicle V, the learning model 1M may repeat relearning based on the actual SOC, power consumption amount, and speed in the travel route of the energy storage device 10 and the corresponding actual travel distance.

The learning model 1M may be learned for each vehicle type and stored in the storage unit 12 according to the vehicle type. The learning model 1M may be learned for each region and stored in the storage unit 12 according to the region.

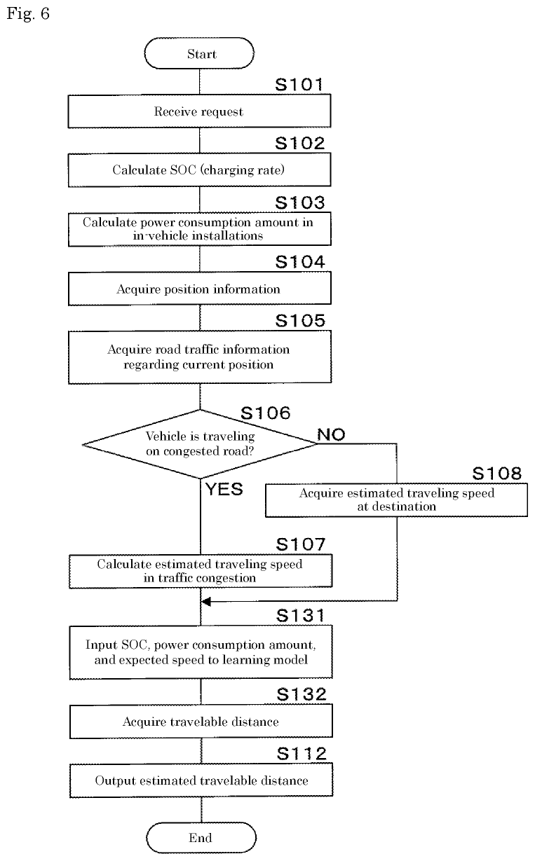

FIG. 6 is a flowchart illustrating an example of a calculation procedure of the travelable distance based on the learning model 1M. Among the processing procedures illustrated in the flowchart of FIG. 6, procedures common to the procedures illustrated in the flowchart of FIG. 2 of the first embodiment are denoted by the same step numbers, and a detailed description thereof is omitted.

The control unit 11 receives the request for calculating the travelable distance (S101), calculates the SOC (S102), calculates the current power consumption amount (S103), and acquires the position information (S104). The control unit 11 calculates the speed depending on whether or not the road is congested (S107, S108).

The SOC, the power consumption amount, and the estimated speed in the travel route calculated in steps S102 to S104, S107, and S108 are input to the learning model 1M (step S131). The learning model 1M outputs the travelable distance according to the input SOC, power consumption amount, and estimated speed in the travel route. The control unit 11 acquires the travelable distance output from the learning model 1M (step S132).

The control unit 11 outputs the travelable distance acquired in step S132 to the output device 34 or the navigation device 31 (S112), and ends the processing.

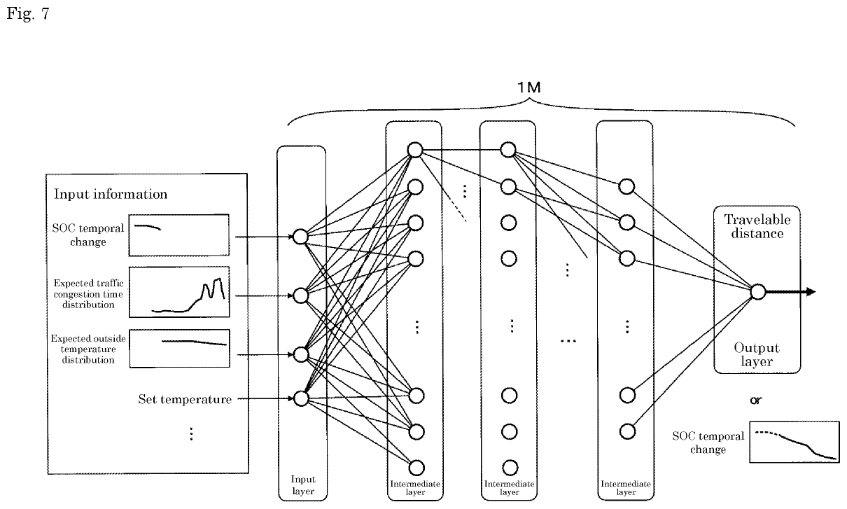

FIG. 7 is a schematic diagram of another example of the learning model 1M. The learning model 1M illustrated in FIG. 7 is learned so as to input the time change in the SOC up to the calculation time point, the time distribution of the degree of traffic congestion expected in the route to the destination set by the navigation device 31, the time distribution of the outside temperature, and the set temperature, and output a reachable distance in the route represented by percent. The learning model 1M may output the subsequent temporal change prediction of the temporal change of the SOC.

As illustrated in FIG. 7, the learning model 1M in another example is learned by a supervised deep learning algorithm using a neural network similarly to the example illustrated in FIG. 5.

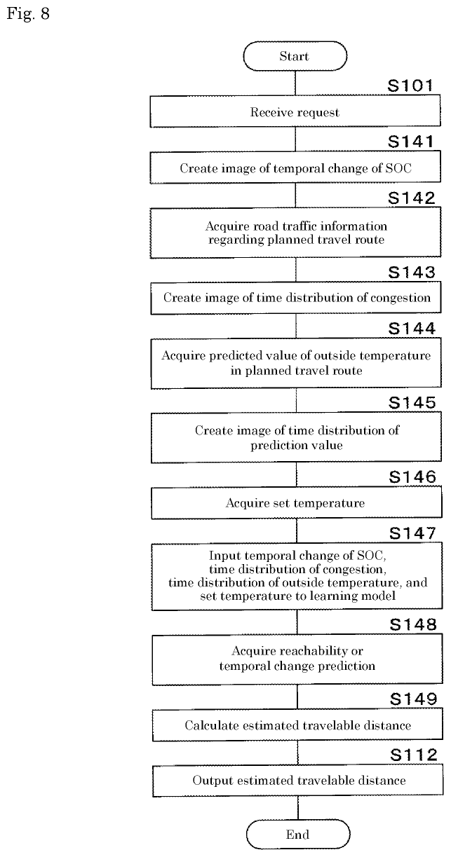

FIG. 8 is a flowchart illustrating another example of the calculation procedure of the travelable distance using the learning model 1M. The processing procedures illustrated in the flowchart of FIG. 8 correspond to the processing procedures in the case of using the learning model 1M of FIG. 7. Among the processing procedures illustrated in the flowchart of FIG. 8, procedures common to the procedures illustrated in the flowchart of FIG. 2 of the first embodiment are denoted by the same step numbers, and a detailed description thereof is omitted.

When receiving the request for calculating the travelable distance (S101), the control unit 11 creates a graph image showing the temporal change of the SOC up to the calculation time point (step S141).

The control unit 11 acquires road traffic information regarding the planned travel route via the communication unit 14 (step S142). The road traffic information in step S142 is traffic congestion prediction information at the expected arrival time. The control unit 11 creates a graph image showing the time distribution of congestion based on the acquired road traffic information (step S143). In step S143, the control unit 11 acquires information on the degree of congestion (congestion length) from the traffic congestion prediction information for each time at each point, and creates the distribution of congestion for each expected arrival time.

The control unit 11 acquires a prediction value of the outside temperature in the planned travel route (step S144). In step S144, information affecting power consumption amount, such as humidity and road undulations, may be acquired. The control unit 11 creates a graph image showing the time distribution of the acquired prediction value (step S145).

The control unit 11 acquires the set temperature of the air conditioner 33 (step S146).

The control unit 11 inputs the graph image of the temporal change of the SOC created in step S141, the graph image of the time distribution of congestion created in step S143, the graph image of the time distribution of the outside temperature created in step S145, and the set temperature to the learning model 1M (step S147).

The control unit 11 acquires the ratio indicating the reachability or the temporal change prediction of the SOC output from the learning model 1M (step S148), and calculates the travelable distance based on the acquired ratio or temporal change prediction (step S149).

The control unit 11 outputs the calculated travelable distance to the output device 34 or the navigation device 31 (step S112), and ends the processing.

As described above, by using the learning model 1M, it is expected that accuracy of calculation of an accurate travelable distance that has been difficult to predict is improved.

### Third Embodiment

In the third embodiment, the information providing server 2 provides information necessary for calculating the temperature, the humidity, and the travelable distance. Since a hardware configuration of the information providing system 100 in the third embodiment is similar to that in the first embodiment, the same reference numerals are given to omit detailed description thereof.

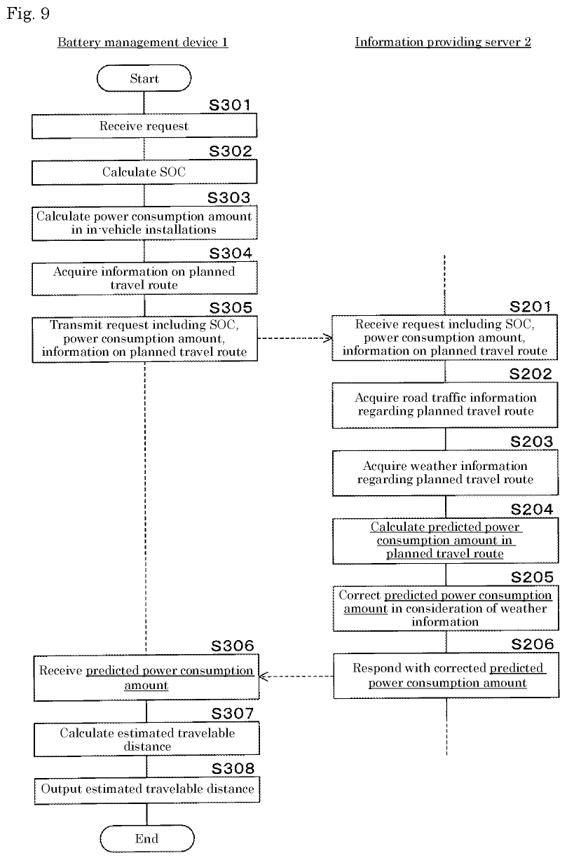

FIG. 9 is a flowchart illustrating an example of a calculation procedure of a travelable distance in the third embodiment. In a case where a destination and a route are set by the navigation device 31, when the navigation device 31 outputs a request for calculating a travelable distance by power from the energy storage device 10 for the set route to the battery management device 1, the following processing is started.

When receiving the request for calculating the travelable distance (step S301), the control unit 11 of the battery management device 1 calculates the SOC of the energy storage device 10 (step S302). In step S302, the control unit 11 may acquire the SOC calculated by the energy storage device 10 via the connection unit 13 as described above.

The control unit 11 calculates power consumption amount in in-vehicle installations including the air conditioner 33 (step S303). In step S303, the control unit 11 may acquire the power consumption amount periodically (for example, every 10 minutes) and calculate the power consumption amount per latest unit time (for example, 1 hour) in step S303.

The control unit 11 acquires information on a planned travel route (step S304). In step S304, the control unit 11 acquires the position information of the route set by the navigation device 31.

The control unit 11 transmits, to the information providing server 2, an information provision request for calculating the travelable distance including the calculated SOC and power consumption amount, the information on the planned travel route, the identification information of the energy storage device 10, and the information on the vehicle type (step S305). The control unit 11 may perform control such that information is directly transmitted from the navigation device 31 to the information providing server 2 without acquiring information on a route in step S304.

The control unit 20 of the information providing server 2 receives the information provision request by the communication unit 22 (step S201). The control unit 20 acquires road traffic information including traffic congestion information in the planned travel route via the network N based on the information of the planned travel route included in the information provision request (step S202). The control unit 20 acquires weather information in the planned travel route via the network N based on the information of the planned travel route included in the information provision request (step S203).

In steps 5202 and 5203, the control unit 20 can not only acquire road traffic information from VICS (registered trademark) or the like via the network N, but also collect information from a plurality of electric vehicles equipped with similar battery management devices 1. The information may be acquired from the vehicle actually traveling on the planned travel route. In this case, the power consumption amount may be acquired from vehicles of the same or similar vehicle types.

The control unit 20 calculates the power consumption prediction amount in the planned travel route based on the road traffic information acquired in step S202 and the SOC and the power consumption amount included in the information provision request (step S204). Based on the weather information acquired in step S203, the control unit 20 corrects the predicted power consumption amount to a power consumption prediction amount in consideration of the operation of the air conditioner 33 (step S205). The output consumption prediction amount obtained in step S205 may be calculated as the power consumption amount per distance.

When the information on the vehicle type is included in the information provision request in steps S204 and S205, the control unit 20 may calculate the power consumption prediction amount from the standard power consumption rate for each vehicle type.

The control unit 20 responds with the corrected power consumption prediction amount to the battery management device 1 (step S206).

The control unit 11 of the battery management device 1 receives the power consumption prediction amount as a response to the information provision request (step S306). The control unit 11 calculates the estimated travelable distance based on the received power consumption prediction amount (step S307), outputs the estimated travelable distance to the output device 34 or the navigation device 31 (step S308), and ends the processing.

The information providing server 2 side may execute up to the calculation of the estimated travelable distance based on the processing procedure illustrated in the flowchart of FIG. 3, and the control unit 20 may respond with the estimated travelable distance in step S206.

As described above, the information providing server 2 side managed by the manufacturer of the energy storage device 10 provides the power consumption prediction amount or the information affecting the power consumption by the information suitable for the characteristics of the energy storage device 10 in the vehicle V. As a result, the calculation accuracy of the travelable distance affected by the situation inside and outside the vehicle is improved.

When the information providing server 2 calculates the travelable distance or the power consumption prediction amount, the information providing server 2 may use the learning model 1M as disclosed in the second embodiment. The learning model 1M for each vehicle type is created in advance and is calculated using the created learning model 1M, whereby the power consumption amount of the energy storage device 10 according to the vehicle type can be accurately predicted, and the travelable distance in the vehicle V can be accurately calculated.

### Fourth Embodiment

In the fourth embodiment, a necessary charging time or charge amount is output based on the power consumption prediction amount corresponding to the shortage. Since a hardware configuration of the information providing system 100 in the fourth embodiment is similar to that in the first embodiment, the same reference numerals are given to omit detailed description thereof.

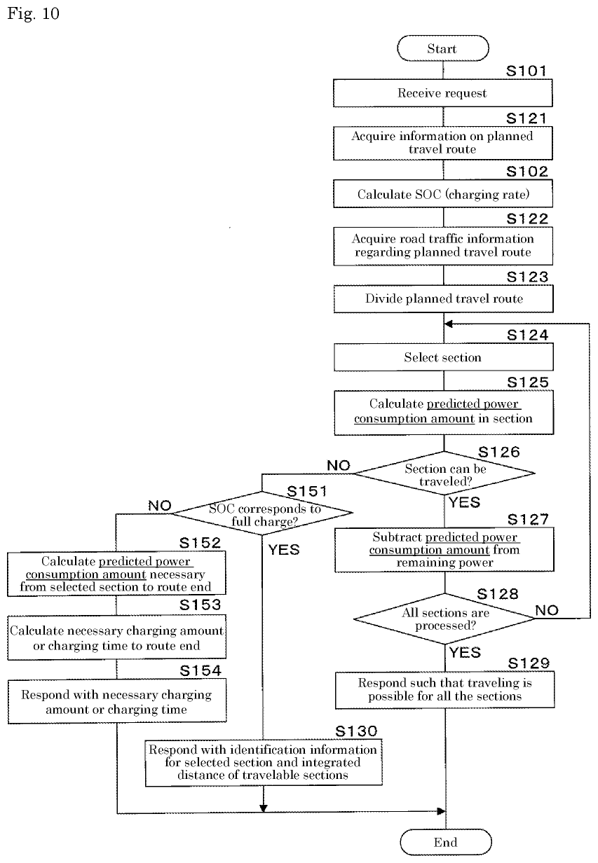

FIG. 10 is a flowchart illustrating an example of a calculation procedure of a travelable distance in the fourth embodiment. In the fourth embodiment, when a destination is set or searched in the navigation device 31, a request for calculating a travelable distance is received from the navigation device 31. Among the processing procedures illustrated in the flowchart of FIG. 10, procedures common to the processing procedures illustrated in the flowchart of FIG. 3 of the first embodiment are denoted by the same step numbers, and a detailed description thereof is omitted.

The control unit 11 of the battery management device 1 receives a request for calculating a travelable distance from the navigation device 31 (S101), and acquires information on a planned travel route (S121).

The control unit 11 calculates the SOC of the energy storage device 10 (S102).

The control unit 11 acquires road traffic information regarding the acquired route (S122). Based on the acquired road traffic information, the control unit 11 divides the planned travel route based on the presence or absence of traffic congestion and the degree of the traffic congestion (S123).

The control unit 11 selects the divided sections in the travel order (S124), calculates the power consumption prediction amount in the selected section (S125), and executes availability of travel (S126).

In the fourth embodiment, when it is determined in step S126 that traveling is not possible in any section (S126: NO), the control unit 11 determines whether or not the current SOC of the vehicle V calculated in step S102 corresponds to full charge (step S151). In step S151, even if the calculated SOC does not reach full charge, the control unit 11 determines that further charge corresponds to full charge when it is determined that the SOC is high enough to stop on the vehicle V side.

When it is determined that the charge corresponds to full charge (S151: YES), the control unit 11 responds to the request with the integrated distance of the section determined to be travelable together with information for identifying the section determined not to be travelable in step S126 and (S130), and ends the processing.

When it is determined that the charge does not correspond to full charge (S151: NO), the control unit 11 calculates a power consumption prediction amount necessary from the section determined not to be travelable to the destination (route end) (step S152). The control unit 11 calculates a necessary charge amount slightly larger than the calculated power consumption prediction amount or a charging time required for charging the necessary charge amount (step S153).

The control unit 11 responds to the request with information for identifying the section determined not to be travelable and the necessary charge amount or the charging time calculated in step S153 (step S154), and ends the processing.

Even when it is determined in step S151 that the charge corresponds to full charge, the control unit 11 may calculate the power consumption prediction amount and the necessary charge amount or the charging time (S153), and add those to the response as information of the necessary charging time on the way.

When receiving the response including the necessary charge amount or the charging time from the battery management device 1, the navigation device 31 that has received the response to the request outputs a message prompting pre-charging to the output device 34. The control unit 11 of the battery management device 1 may directly cause the output device 34 to output a message prompting charging.

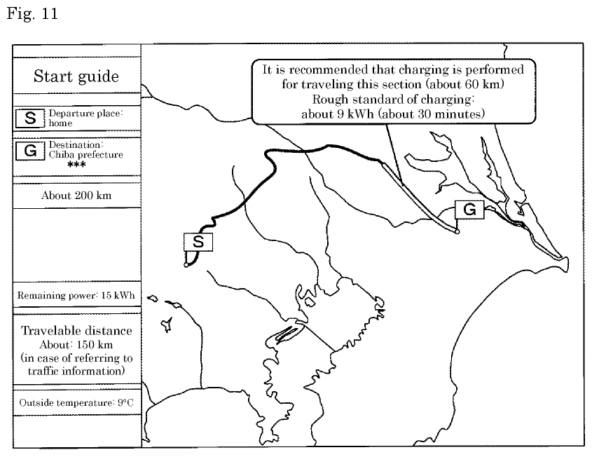

FIG. 11 is a diagram illustrating an example of a charging message to be output. FIG. 11 illustrates a navigation screen by the navigation device 31. On the navigation screen, a route set by the navigation device 31 is displayed on a map, and a section in which power is insufficient with the current SOC of the vehicle V is highlighted on the map. In the example of FIG. 11, it is determined that the energy storage device 10 of the vehicle V does not correspond to full charge, and a necessary watt-hour and a charging time are presented. In this way, even if the vehicle V is not fully charged, in a case where the vehicle V can travel the entire route by being charged even a little, the user can recognize this and appropriately prepare charging in advance, and travel with security.

In a case where it is predicted that charging is necessary until a destination (route end) in the planned travel route by cooperation of the battery management device 1 and the navigation device 31, a charging stand may be added to the planned travel route, and the processing procedure illustrated in the flowchart of FIG. 11 may be executed again to present a necessary charge amount or a charging time in the charging stand at the stopping point.

The processing procedure described in the fourth embodiment is not limited to being implemented in cooperation with the navigation device 31 mounted on the vehicle V. For example, the SOC of the energy storage device 10 of the vehicle V may be acquired by an information terminal device (such as a smartphone) of the driver, and the information terminal device may calculate the travelable distance. In this case, when searching a destination of the next day using the information terminal device, a user having a charging installation at home checks whether or not the user can travel the entire route including a route to the destination and a route to return home based on the SOC of the energy storage device 10 using the information terminal device. The information terminal device calculates a travelable distance by a function similar to that of the battery management device 1, and when it is determined that the entire route cannot be traveled, the information terminal device can prompt charging in advance. In this case, the driver can grasp how much charging should be performed before departure, and does not have to be anxious until reaching the destination.

The vehicle V may be an industrial vehicle such as an automated guided vehicle (AGV) or a truck that transports loads on a site, and is not limited to an electric automobile as long as it is an electric vehicle that uses power as a driving force. Furthermore, as described in the following fifth embodiment, the target of the battery management device 1 can be an airplane, a ship, a spacecraft, or the like that moves using an energy storage device as a power source, instead of a vehicle.

### Fifth Embodiment

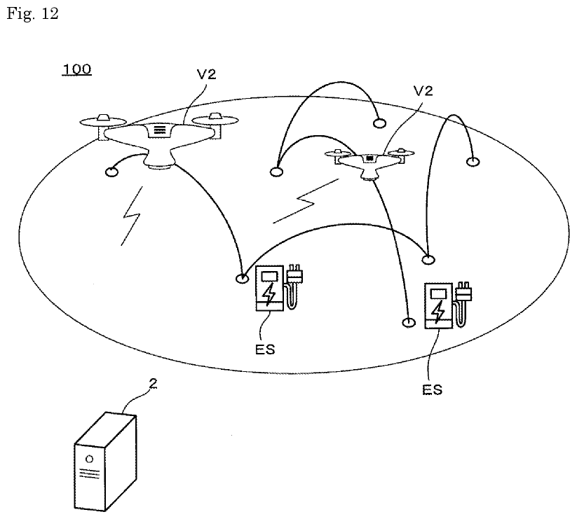

In the fifth embodiment, a target of the battery management device 1 is a flight vehicle V2 that is a manned eVTOL. FIG. 12 is a schematic diagram of the information providing system 100 in the fifth embodiment. Since the configuration of the information providing system 100 in the fifth embodiment is similar to that of the first embodiment except that the processing for the flight vehicle V2 is executed, detailed description of the hardware configuration is omitted.

The battery management device 1 in the fifth embodiment is mounted on the flight vehicle V2 that flies along a route as illustrated in FIG. 1. The battery management device 1 is connected to the energy storage device 10 of the flight vehicle V2. The battery management device 1 can be communicably connectable to a device that acquires position information of the flight vehicle V2 and route information of a planned moving route. For example, the battery management device 1 acquires position information from a GPS receiver mounted on the flight vehicle V2, and acquires route information from a navigation control device (not illustrated). Here, the navigation control device is a device that controls a flight based on a route instructed from a driver or an external instruction system and a latitude, a longitude, and an altitude.

The battery management device 1 can be communicably connected to the information providing server 2. In the fifth embodiment, the battery management device 1 can transmit and receive data to and from the information providing server 2 by communication via a communication device that is mounted on the flight vehicle V2 and communicates with the outside.

The battery management device 1 can be communicably connected to an air conditioner mounted on the flight vehicle V2. The battery management device 1 may be able to be communicably connected to an atmospheric pressure adjustment device mounted on the flight vehicle V2. The battery management device 1 may be connected to an output device that outputs information to a driver of the flight vehicle V2.

The control unit 20 of the information providing server 2 of the fifth embodiment can acquire, based on the information providing program 2P, information regarding factors affecting the power consumption of the flight vehicle V2, such as map information, outside temperature data for each altitude, wind speed data, and a congestion status for each of the departure and arrival points, and store the acquired information in the storage unit 21. The control unit 20 can acquire information on the actual measurement value or the prediction value of the atmospheric pressure distribution for each altitude associated with the position information based on the information providing program 2P and store the acquired information in the storage unit 21.

In the information providing system 100 in the fifth embodiment, the battery management device 1 mounted on the flight vehicle V2 estimates the travelable distance in consideration of the prediction of the power consumption amount inside and outside the flight vehicle V2 based on the position information of the flight vehicle V2, the position information of a charging stand ES, the power consumption prediction amount in the moving route of the flight vehicle V2, and the state of charge of the energy storage device 10. A part of the predicted power consumption amount is provided from the information providing server 2.

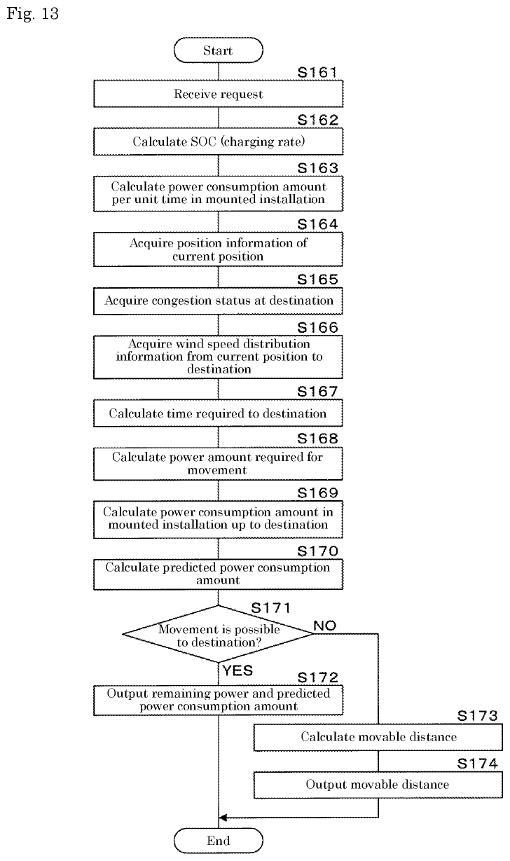

FIG. 13 is a flowchart illustrating an example of a processing procedure executed by the battery management device 1 according to the fifth embodiment. The control unit 11 receives a request for a movable distance (step S161).

The control unit 11 acquires measurement data from the energy storage device 10 and calculates an SOC (step S162). In step S162, the control unit 11 may acquire the calculated SOC.

The control unit 11 calculates the power consumption amount per time in the installation mounted on the flight vehicle V2 including the air conditioner (step S163). In step S163, the control unit 11 may acquire the power consumption amount periodically (for example, every 10 minutes) and calculate the power consumption amount per latest unit time (for example, 15 minutes, 30 minutes, 1 hour, and the like) in step S163.

In step S163, the control unit 11 acquires the outside temperature, the outside humidity, the room temperature, and the humidity from a temperature and humidity sensor (not illustrated), and predicts the power consumption amount by the air conditioner based on the temperature difference and the humidity difference, or corrects the power consumption amount in step S163 based on the temperature difference. The control unit 11 may acquire the altitude and the external atmospheric pressure from an altitude sensor and an atmospheric pressure sensor (not illustrated), and predict or correct the power consumption amount in view of the power consumption by the atmospheric pressure adjustment device.

The control unit 11 acquires position information indicating the current position of the flight vehicle V2 (step S164).

The control unit 11 acquires information indicating the congestion status of departure and arrival at the set destination from the information providing server 2 via the communication unit 14 (step S165). In step S165, the control unit 11 acquires an average time required for taking in and out the destination.

The control unit 11 acquires the distribution information of the wind speed from the current position to the set destination from the information providing server 2 via the communication unit 14 (step S166).

The control unit 11 calculates the time required for the movement to the destination based on the acquired environmental information including the information indicating the congestion status and the information on the wind speed and the distance from the current location to the destination (step S167), and predicts the watt-hour required for the movement (step S168).

The control unit 11 calculates the watt-hour consumed in the installation up to the destination based on the power consumption amount per time calculated in step S163 (step S169), and calculates the predicted power consumption amount together with the power required for the movement calculated in step S168 (step S170).

The control unit 11 determines whether or not movement is possible for the distance to the destination based on the remaining power based on the SOC calculated in step S162 and the predicted power consumption amount calculated in step S170 (step S171). In step S171, as an example, the control unit 11 may compare the remaining watt-hour with the predicted power consumption amount and determine that the movement is possible when the remaining watt-hour is larger. The control unit 11 may calculate the power consumption amount per unit time, calculate the distance, and then compare the calculated distance with the distance to the destination.

When it is determined that the moving is possible (S171: YES), the control unit 11 outputs the remaining watt-hour and the predicted power consumption amount (step S172), and ends the processing.

When it is determined in step S171 that the moving is not possible (S171: NO), the movable distance is calculated based on the predicted power consumption amount and the ratio to the remaining watt-hour (step S173) and output (step S174), and the processing is ended.

In step S174, the control unit 11 may transmit, to the information providing server 2, a search request for a departure/arrival place where the charging stand ES located within a movable distance from the current location is provided. The control unit 11 outputs together the candidates for the departure/arrival place that have been responded to the request. The control unit 11 calculates the watt-hour to be charged by the charging stand ES when the vehicle arrives at the candidate for the departure/arrival place using the remaining watt-hour and the predicted power consumption amount. When the vehicle arrives at the departure/arrival place selected from the candidates, the control unit 11 may determine the charge watt-hour again at the timing of being connected to the charging stand ES and execute charging.

As described in the fifth embodiment, the calculation target of the movable distance by the battery management device 1 is not limited to the electric automobile. Similarly, the processing by the battery management device 1 can also be applied to an unmanned airplane called a drone. The processing by the battery management device 1 can also be applied to battery management in an electric ship that is equipped with an energy storage device and navigated by power. In a case where the processing by the battery management device 1 is applied to the electric ship, the control unit 11 predicts and corrects the power consumption amount in view of the information regarding the tidal current in addition to the temperature, the wind speed, and the wave height. The processing by the battery management device 1 can also be applied to battery management in a flight vehicle such as a spacecraft or a satellite that is navigated using power and requires more precise management.

The embodiments disclosed as described above are illustrative in all respects and are not restrictive. The scope of the present invention is defined by the scope of the claims, and includes meanings equivalent to the scope of the claims and all modifications within the scope.

1. A battery management device, comprising a calculation unit that calculates a movable distance based on a state of charge of an energy storage device serving as a power source of an electric moving body,
the calculation unit being configured to:
acquire a state of charge of the energy storage device;
acquire environmental information in a planned route of the electric moving body;
calculate, from the acquired state of charge and environmental information, a power consumption amount predicted based on a necessary watt-hour necessary for the electric moving body to move along the planned route and a prediction of a power consumption amount in an installation mounted on the electric moving body; and
calculate a movable distance achieved by remaining power of the energy storage device based on the calculated predicted power consumption amount and the state of charge.

2. The battery management device according to claim 1, which is configured to:
divide the planned route of the electric moving body;
predict the necessary watt-hour and the power consumption amount in the installation based on the environmental information for each divided section;
determine, for each section, whether or not the electric moving body is movable in the section based on the state of charge; and
calculate a distance to a section determined not to be movable as a movable distance.

3. The battery management device according to claim 1, wherein the calculation unit is configured to calculate a movable distance by using a learning model learned so as to output a movable distance using the energy storage device having the state of charge as a power source according to an input of the state of charge of the energy storage device, congestion information in the planned route, and the predicted power consumption amount calculated for the planned route.

4. The battery management device according to claim 1, wherein the calculation unit is configured to calculate a movable distance using a learning model learned so as to output a movable distance using the energy storage device having the state of charge as a power source or a temporal change in the state of charge after a calculation time point of the energy storage device according to an input of a temporal change in the state of charge of the energy storage device up to the calculation time point, a congestion time distribution predicted for the planned route, and an expected distribution of an outside temperature in the planned route.

5. The battery management device according to claim 3, wherein the learning model inputs a planned route time of the planned route.

6. The battery management device according to claim 1, which is configured to:
determine whether or not moving along an entire route of the planned route is possible based on the calculated movable distance; and
output a message prompting pre-charging of the energy storage device when it is determined that moving is not possible in a part of the planned route.

7. The battery management device according to claim 6, which is configured to:
calculate a predicted power consumption amount in the part based on a predicted power consumption amount necessary for movement on the planned route and the state of charge; and
output a message including a charging time or a charge amount of the pre-charging to charge power corresponding to the calculated predicted power consumption amount.

8. The battery management device according to claim 1, which is configured to:
acquire the state of charge of the energy storage device at a predetermined timing while the battery management device is activated;
determine whether or not the state of charge has become a predetermined value or less for each time the state of charge is acquired; and
start calculation of a movable distance by the calculation unit when it is determined that the state of charge is equal to or less than the predetermined value.

9. The battery management device according to claim 1, wherein the electric moving body is a manned vehicle.

10. The battery management device according to claim 1, wherein a power source of the electric moving body does not include an engine.

11. The battery management device according to claim 1, wherein the environmental information includes at least one of pieces of information regarding a traffic condition, traffic congestion, a congestion condition, a temperature, an atmospheric pressure, an altitude, humidity, a wind speed, a wave height, and a tidal current in a planned route.

12-14. (canceled)

15. An information providing device capable of transmitting and receiving information to and from an electric moving body by communication and configured to provide information for calculating a movable distance achieved by remaining power of an energy storage device serving as a power source of the electric moving body, the information providing device being configured to:
receive information on a state of charge of the energy storage device, a planned route, and a power consumption amount;
acquire environmental information in a planned route of the electric moving body;
calculate, from the acquired state of charge and environmental information, a power consumption amount in the planned route predicted based on a watt-hour necessary for the electric moving body to move along the planned route and a power consumption amount in an installation mounted on the electric moving body; and
transmit the calculated predicted power consumption amount to the electric moving body.

16. A battery management device configured to manage charge-discharge of an energy storage device serving as a power source of an electric moving body, the battery management device comprising a calculation unit configured to acquire environmental information in a planned route of movement of the electric moving body, and calculate, from an acquired state of charge and the acquired environmental information, a power consumption amount predicted based on a watt-hour necessary for the electric moving body to move along the planned route and a prediction of a power consumption amount in an installation mounted on the electric moving body,
the battery management device being configured to determine a charge amount of the energy storage device based on the calculated predicted power consumption amount and the state of charge of the energy storage device, and charge the energy storage device with the determined charge amount.
